(19) United States
(12) Patent Application Publication
(10) Pub. No.: US 2022/0172334 A1
(43) Pub. Date: Jun. 2, 2022

(54) IMAGE INSPECTION APPARATUS AND NON-TRANSITORY COMPUTER READABLE MEDIUM STORING IMAGE INSPECTION PROGRAM

(71) Applicant: FUJIFILM Business Innovation Corp., Tokyo (JP)

(72) Inventors: Rina TAKEUCHI, Kanagawa (JP); Daigo HAMA, Kanagawa (JP)

(73) Assignee: FUJIFILM Business Innovation Corp., Tokyo (JP)

(21) Appl. No.: 17/342,552

(22) Filed: Jun. 9, 2021

(30) Foreign Application Priority Data
Nov. 30, 2020 (JP) 2020-198468

(51) Int. Cl. G06T 7/00; G06T 1/00; G06T 1/20

(52) U.S. Cl. CPC G06T 7/001; G06T 2207/30108; G06T 1/20; G06T 1/0007

(57) ABSTRACT

An image inspection apparatus includes a processor configured to: divide a read image obtained by reading a printed image and a reference image representing an original shape of the printed image into plural regions having the identical shape, respectively; set a movement direction of the region for each of the divided regions of the reference image according to a feature of the reference image in the region; and inspect a deviation between the read image and the reference image for each of corresponding regions of the read image and the reference image by moving the region of the reference image in the movement direction which is set for the region.

### CROSS-REFERENCE TO RELATED APPLICATIONS

This application is based on and claims priority under 35 USC 119 from Japanese Patent Application No. 2020-198468 filed Nov. 30, 2020.

### BACKGROUND

### (i) Technical Field

The present invention relates to an image inspection apparatus and a non-transitory computer readable medium storing an image inspection program.

### (ii) Related Art

JP2013-186562A discloses an image inspection apparatus that performs inspection by collating a read image obtained by reading an image formed on paper by using an image forming apparatus with an original reference image. The image inspection apparatus includes an inspection and comparison unit for comparison and collation. In the image inspection apparatus, the inspection and comparison unit divides the entire image into a plurality of blocks, performs first alignment in a plurality of regions in the vicinity of the image, calculates a misalignment amount of each block of the read image based on a result of the first alignment, and performs alignment while slightly shifting the block of the read image shifted according to the misalignment amount and the block of the reference image. Further, the inspection and comparison unit selects a predetermined block in the image, performs second alignment by recalculating a misalignment amount of the selected block, and corrects the misalignment amount of each block of the read image based on a result of the second alignment.

### SUMMARY

The read image obtained by reading the image, which is formed on paper by the image forming apparatus, using an optical apparatus such as a scanner is an input image of the image inspection apparatus. Due to, for example, a misalignment of the paper, the read image may be misaligned with respect to the reference image as a source of the read image.

In the related art, in a case of inspecting whether or not there is a deviation between the read image and the reference image, the deviation between the read image and the reference image is calculated from a movement amount of the reference image by dividing the read image and the reference image into a plurality of regions and detecting a position at which the image included in the region of the corresponding read image and the image included in the region of the reference image maximally match with each other while moving the region of the reference image in all directions for each region.

However, in a case of the inspection method, it is necessary to detect the position at which the image included in the region of the corresponding read image and the image included in the region of the reference image maximally overlap with each other while moving the region of the reference image by trial and error. As a result, it takes a time to complete the inspection.

Aspects of non-limiting embodiments of the present disclosure relate to provide an image inspection apparatus and a non-transitory computer readable medium storing an image inspection program capable of shortening an inspection time as compared with a case of inspecting a deviation between the read image and the reference image for each region obtained by dividing the read image as an image inspection target and the reference image while moving the region without setting the movement direction of the region.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image inspection apparatus includes a processor configured to: divide a read image obtained by reading a printed image and a reference image representing an original shape of the printed image into a plurality of regions having the identical shape, respectively; set a movement direction of the region for each of the divided regions of the reference image according to a feature of the reference image in the region; and inspect a deviation between the read image and the reference image for each of corresponding regions of the read image and the reference image by moving the region of the reference image in the movement direction which is set for the region.

### BRIEF DESCRIPTION OF THE DRAWINGS

Exemplary embodiment(s) of the present invention will be described in detail based on the following figures, wherein:

FIG. 1 is a diagram illustrating a functional configuration example of an image inspection apparatus;

FIG. 2 is a diagram illustrating an example of a read image;

FIG. 3 is a diagram illustrating an example of a reference image;

FIGS. 4A and 4B are diagrams illustrating an example of a divided read image and a divided reference image;

FIG. 5 is a diagram illustrating an example of a movement direction of a reference image block;

FIG. 6 is a diagram illustrating a configuration example of a main part of an electric system of the image inspection apparatus;

FIG. 7 is a flowchart illustrating an example of a flow of inspection processing;

FIGS. 8A and 8B are diagrams illustrating a division example of the read image and the reference image;

FIG. 9 is a diagram illustrating a classification example in which the reference image blocks are classified into categories;

FIG. 10 is a diagram illustrating an expansion example of the reference image block; and

FIG. 11 is a diagram illustrating an example in which the reference image is divided into the reference image blocks having different sizes.

### DETAILED DESCRIPTION

Hereinafter, an exemplary embodiment of the present invention will be described with reference to the drawings. The same components and the same processing are denoted by the same reference numerals throughout the drawings, and repeated descriptions will be omitted.

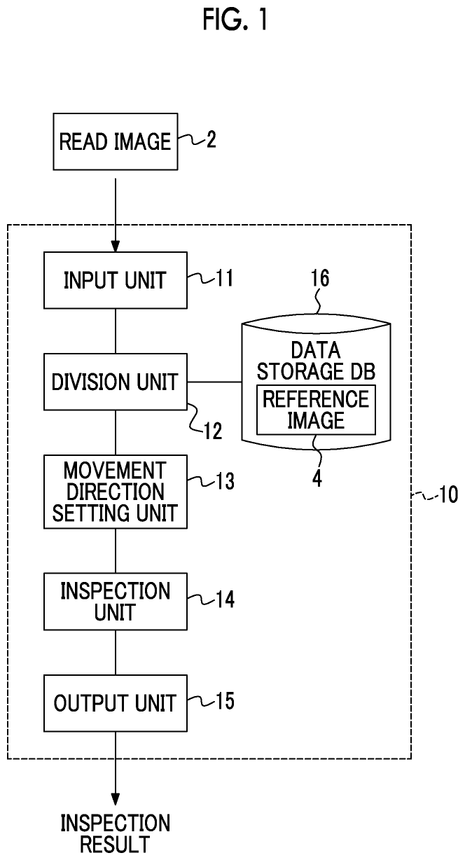

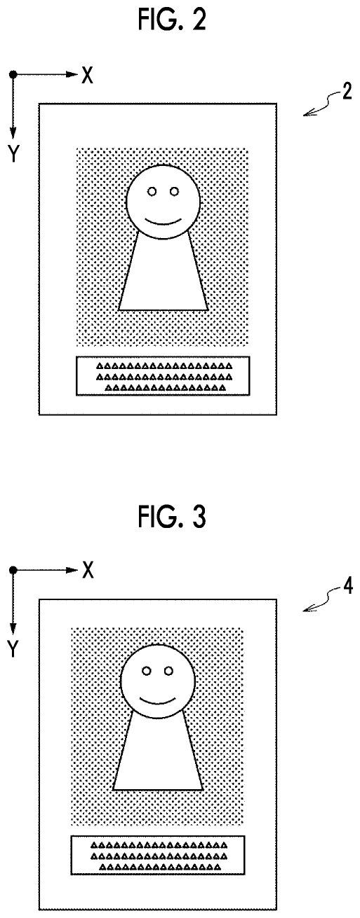

FIG. 1 is a diagram illustrating a functional configuration example of an image inspection apparatus 10 according to the exemplary embodiment of the present invention. The image inspection apparatus 10 inspects whether a deviation of a read image 2 with respect to a reference image 4 is within an allowable range by comparing a deviation between the read image 2 and the reference image 4. The read image 2 is a printed image printed on paper by an image forming apparatus (not illustrated), that is, an image obtained by reading a printed matter using an optical apparatus such as a scanner, and FIG. 2 illustrates an example of the read image 2. Further, the reference image 4 is an original image of a printed image printed by an image forming apparatus (not illustrated), that is, an image representing an original shape of the read image 2. FIG. 3 illustrates an example of the reference image 4 with respect to the read image 2 illustrated in FIG. 2.

It is noted that positions of pixels of the read image 2 and the reference image 4 are represented by, for example, two-dimensional coordinates on an X-axis and a Y-axis in a case where an upper left vertex of each image is set as an origin. The Y-axis is an axis along a vertical direction of each of the read image 2 and the reference image 4, and the X-axis is an axis along a horizontal direction of each of the read image 2 and the reference image 4. For this reason, the vertical direction of each of the read image 2 and the reference image 4 is represented by a “Y-axis direction”, and the horizontal direction of each of the read image 2 and the reference image 4 is represented by an “X-axis direction”.

In a case where the deviation of the read image 2 with respect to the reference image 4 is not within the allowable range, the printed matter corresponding to the read image 2 is a defective product, and thus a procedure such as non-shipping of the printed matter is performed.

Therefore, in response to input of the read image 2, the image inspection apparatus 10 outputs an inspection result including whether or not the deviation of the read image 2 with respect to the reference image 4 is within the allowable range.

The image inspection apparatus 10 includes functional units of an input unit 11, a division unit 12, a movement direction setting unit 13, an inspection unit 14, and an output unit 15, and a data storage DB 16 that stores the reference image 4.

The input unit 11 receives the read image 2 as an inspection target, and notifies the division unit 12 of the received read image 2.

In a case where the division unit 12 receives the read image 2 from the input unit 11, the division unit 12 acquires the reference image 4 which is an original image of the read image 2 from the data storage DB 16. Then, the division unit 12 divides the read image 2 and the reference image 4 into a plurality of regions. Hereinafter, each of the plurality of divided regions is referred to as a “block”.

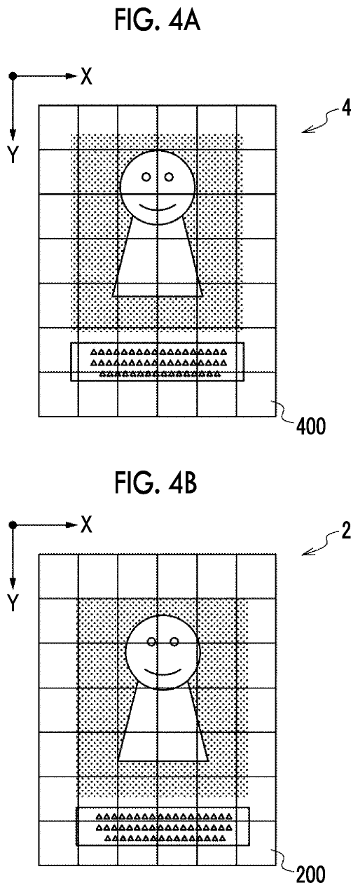

FIGS. 4A and 4B are diagrams illustrating an example of the read image 2 and the reference image 4 which are divided into blocks by the division unit 12. FIG. 4A illustrates an example of the reference image 4 divided into blocks, and FIG. 4B illustrates an example of the read image 2 divided into blocks.

There is no restriction on a shape and a size of each of the blocks divided by the division unit 12. In this description, as an example, the read image 2 and the reference image 4 are respectively divided in a grid pattern along the X-axis direction and the Y-axis direction. In the blocks divided in a grid pattern, the shape of each block is rectangular, and the size of each block is identical. In addition, the blocks are divided in a predetermined size.

Each block of the reference image 4 is represented as “a reference image block 400”, and each block of the read image 2 is represented as “a read image block 200”. In a case where the read image 2 and the reference image 4 are overlapped with each other, the read image block 200 and the reference image block 400 at the identical position are represented as “the read image block 200 corresponding to the reference image block 400”.

After the division unit 12 divides the read image 2 and the reference image 4 into the plurality of blocks, the division unit 12 notifies the movement direction setting unit 13 of division completion.

In a case where the movement direction setting unit 13 receives, from the division unit 12, a notification that the division into the blocks is completed, the movement direction setting unit 13 sets a movement direction of the reference image block 400 for each reference image block 400 according to a feature of an image in the reference image block 400, that is, a feature of a block image of the reference image block 400.

The movement direction setting unit 13 sets, as a movement direction of the reference image block 400, a specific direction in which the reference image block 400 may move, instead of setting a movement direction of the reference image block 400 such that the reference image block 400 can move in any direction of 360 degrees in a case of being viewed from a center of the reference image block 400. That is, the movement direction of the reference image block 400 is restricted.

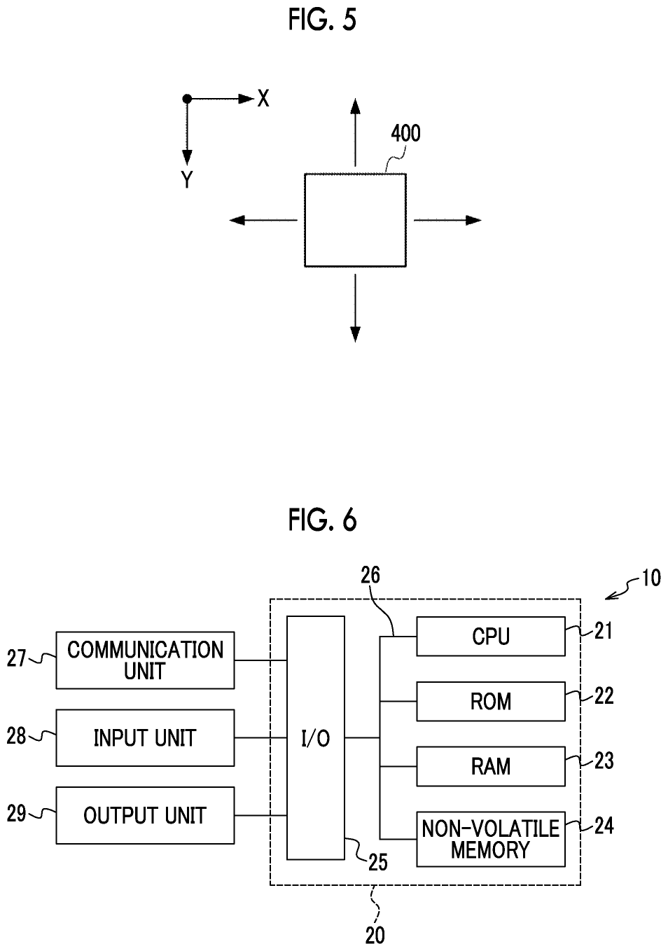

FIG. 5 is a diagram illustrating an example of a movement direction which is set for the reference image block 400. In the example illustrated in FIG. 5, the movement direction for the reference image block 400 is set along the X-axis direction and the Y-axis direction. In this case, the reference image block 400 can move in directions along the X-axis direction and the Y-axis direction, and cannot move, for example, in a direction in which an angle formed by the X-axis direction is 45 degrees.

The movement direction setting unit 13 sets the movement direction for each of the reference image blocks 400 divided from the reference image 4, and then notifies the inspection unit 14 of movement direction setting completion.

In a case where the inspection unit 14 receives a notification of movement direction setting completion from the movement direction setting unit 13, for example, the inspection unit 14 overlaps the reference image block 400 and the read image block 200 such that vertexes of the reference image block 400 and vertexes of the read image block 200 corresponding to the reference image block 400 match with each other for each reference image block 400. A position at which the reference image block 400 and the read image block 200 are overlapped with each other such that at least one vertex of the reference image block 400 and at least one vertex of the read image block 200 match with each other is referred to as a “reference position”.

From this state, the inspection unit 14 detects a position at which the block image of the reference image block 400 and the block image of the read image block 200 most overlap with each other (hereinafter, referred to as a “collation position”) while moving the reference image block 400 in the movement direction which is set by the movement direction setting unit 13.

The inspection unit 14 represents a movement amount of the reference image block 400 from the reference position to the collation position by the number of pixels. For example, in a case where an average value of the movement amounts of each reference image block 400 is equal to or larger than a predetermined reference threshold value, the inspection unit 14 determines that there is a deviation between the read image 2 and the reference image 4, and sets an inspection result to “fail”. On the other hand, in a case where the average value of the movement amounts of each reference image block 400 is smaller than the predetermined reference threshold value, the inspection unit 14 determines that there is no deviation between the read image 2 and the reference image 4, and set an inspection result to “pass”. The inspection unit 14 notifies the output unit 15 of the inspection result for the read image 2.

In a case where the output unit 15 receives the inspection result from the inspection unit 14, the output unit 15 outputs the received inspection result. Thereby, whether the printed matter corresponding to the read image 2 is a non-defective product or a defective product is specified. The “output” according to the exemplary embodiment of the present invention refers to making the inspection result into a recognizable state, and includes a form of displaying the inspection result, a form of printing the inspection result on a recording medium such as paper, a form of notifying the inspection result by voice, a form of storing the inspection result in a storage device, and a form of transmitting the inspection result to an apparatus other than the image inspection apparatus 10 (hereinafter, referred to as an “external apparatus”) via a communication line (not illustrated).

The data storage DB 16 stores the reference image 4. The “DB” is an abbreviation for a database, and the data storage DB 16 provides a management function of the reference image 4 such as storing of the reference image 4, reading of the reference image 4, and deletion of the reference image 4.

The image inspection apparatus 10 is configured by using, for example, a computer 20.

FIG. 6 is a diagram illustrating a configuration example of a main part of an electric system of the image inspection apparatus 10 in a case where the image inspection apparatus 10 is configured by using the computer 20.

The computer 20 includes a central processing unit (CPU) 21, which is an example of a processor that handles processing of each functional unit of the image inspection apparatus 10 illustrated in FIG. 1, a read only memory (ROM) 22 that stores an image inspection program, a random access memory (RAM) 23 that is used as a temporary work area of the CPU 21, a non-volatile memory 24, and an input/output interface (I/O) 25. The CPU 21, the ROM 22, the RAM 23, the non-volatile memory 24, and the I/O 25 are connected to each other via a bus 26.

The non-volatile memory 24 is an example of a storage device that maintains the stored information even in a case where power supplied to the non-volatile memory 24 is cut off. As the non-volatile memory 24, for example, a semiconductor memory is used. On the other hand, a hard disk may be used. The non-volatile memory 24 does not necessarily have to be built in the computer 20, and may be a storage device such as a memory card that is detachably attached to the computer 20. The data storage DB 16 is stored in the non-volatile memory 24.

For example, a communication unit 27, an input unit 28, and an output unit 29 are connected to the I/O 25.

The communication unit 27 is connected to a communication line (not illustrated) and includes a communication protocol for performing communication with an external apparatus connected to the communication line. The communication line (not illustrated) includes a known communication line such as the Internet or a local area network (LAN). The communication line (not illustrated) may be wired or wireless.

The input unit 28 is a device that receives an instruction from a user and notifies the CPU 21 of the instruction, and includes, for example, a button, a touch panel, a keyboard, a pointing device, and a mouse. The image inspection apparatus 10 may receive an instruction from a user by voice, and in this case, a microphone is used as the input unit 28.

The output unit 29 is a device that outputs information processed by the CPU 21, and includes, for example, a liquid crystal display, an organic electro luminescence (EL) display, a display device such as a projector that projects a video on a screen, a speaker, an image forming unit that forms texts and figures on a recording medium, and a storage device that stores information.

The image inspection apparatus 10 does not necessarily include all the units connected to the I/O 25 and illustrated in FIG. 6, and the necessary units may be connected to the I/O 25 depending on a situation. For example, in a case where the image inspection apparatus 10 operates offline, the communication unit 27 is not always necessary.

Next, an operation of the image inspection apparatus 10 will be described in detail.

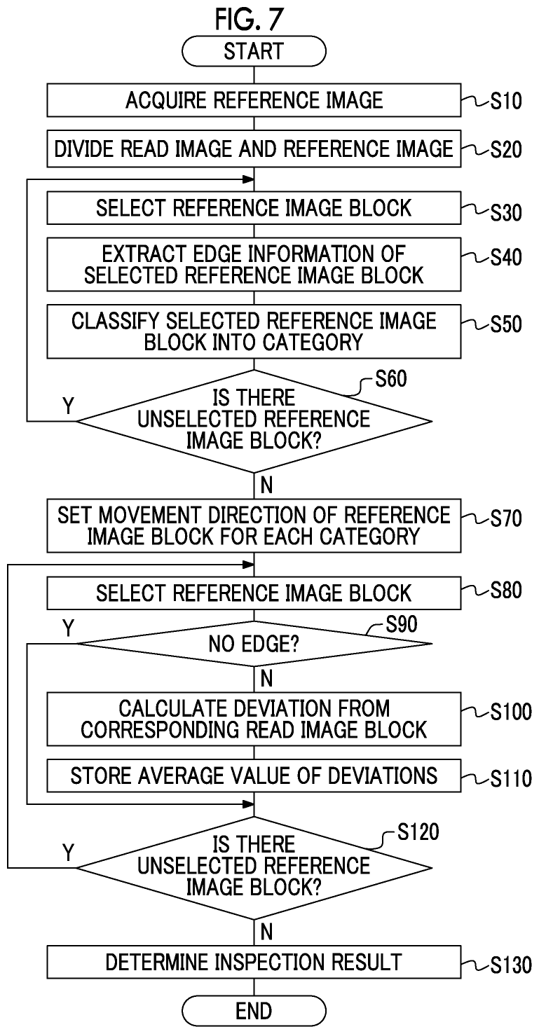

FIG. 7 is a flowchart illustrating an example of a flow of inspection processing executed by the CPU 21 in a case where the image inspection apparatus 10 receives the read image 2. The image inspection program that defines the inspection processing is stored in advance in, for example, the ROM 22 of the image inspection apparatus 10. The CPU 21 of the image inspection apparatus 10 reads the image inspection program stored in the ROM 22, and executes the inspection processing.

In step S10, the CPU 21 acquires the reference image 4 corresponding to the received read image 2 from the non-volatile memory 24. Specifically, the CPU 21 may acquire the reference image 4 corresponding to the read image 2 from the non-volatile memory 24 by referring to an image ID assigned to the read image 2.

The CPU 21 may acquire the reference image 4 from an external apparatus via a communication line (not illustrated) instead of acquiring the reference image 4 from the non-volatile memory 24.

In step S20, the CPU 21 respectively divides the read image 2 and the reference image 4 which is acquired in step S10 into read image blocks 200 and reference image blocks 400 as illustrated in FIGS. 4A and 4B.

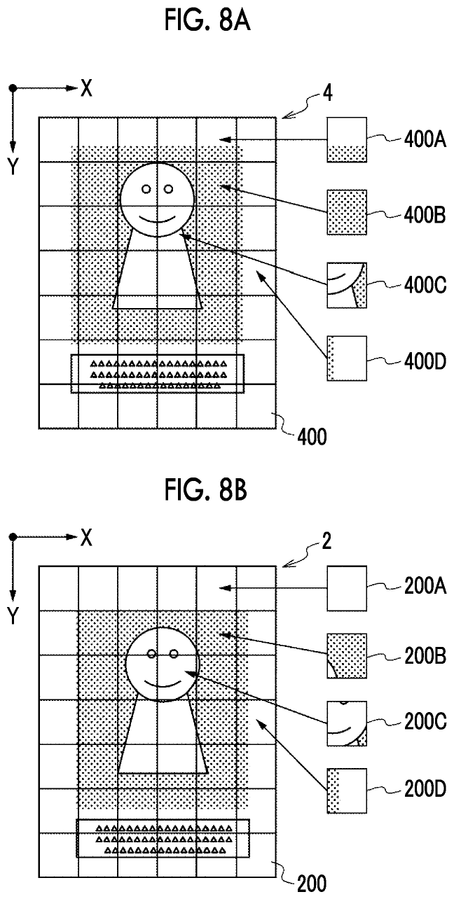

FIGS. 8A and 8B are diagrams illustrating a division example of the read image 2 and the reference image 4. FIG. 8A is a division example of the reference image 4 illustrated in FIG. 3, and FIG. 8B is a division example of the read image 2 illustrated in FIG. 2. In the example of FIGS. 8A and 8B, the reference image 4 and the read image 2 are respectively divided in a grid pattern to have a predetermined size such that each reference image block 400 and each read image block 200 do not respectively overlap with the adjacent reference image block 400 and the adjacent read image block 200.

In step S30, the CPU 21 selects, from a plurality of reference image blocks 400 divided in step S20, any one reference image block 400 that is not yet selected. For the convenience of explanation, the selected reference image block 400 will be referred to as a “selected reference image block 400”.

In step S40, the CPU 21 extracts edge information of the block image from the selected reference image block 400. An “edge” is a set of pixels located at a boundary at which color information of a pixel that is represented by a pixel value changes by a predetermined threshold value or more between adjacent pixels, and is also called a “contour line”. As the color information of a pixel, at least one of a hue, a chroma, or brightness is used. Thus, in addition to a line, boundaries in color and brightness are also extracted as edges.

For example, in FIG. 8A, in a case where the reference image block 400A is selected as the selected reference image block 400, an edge along the X-axis direction is extracted from the reference image block 400A. In a case where the reference image block 400B is selected as the selected reference image block 400, an edge is not extracted because the block image of the reference image block 400B is all colored with the identical density. In a case where the reference image block 400C is selected as the selected reference image block 400, edges represented by a curved line and a straight line are extracted from the reference image block 400C. In a case where the reference image block 400D is selected as the selected reference image block 400, an edge along the Y-axis direction is extracted from the reference image block 400D.

In step S50, the CPU 21 specifies a direction of the edge of the block image of the selected reference image block 400 based on the edge information extracted in step S40, and classifies the selected reference image block 400 into a category according to the direction of the edge.

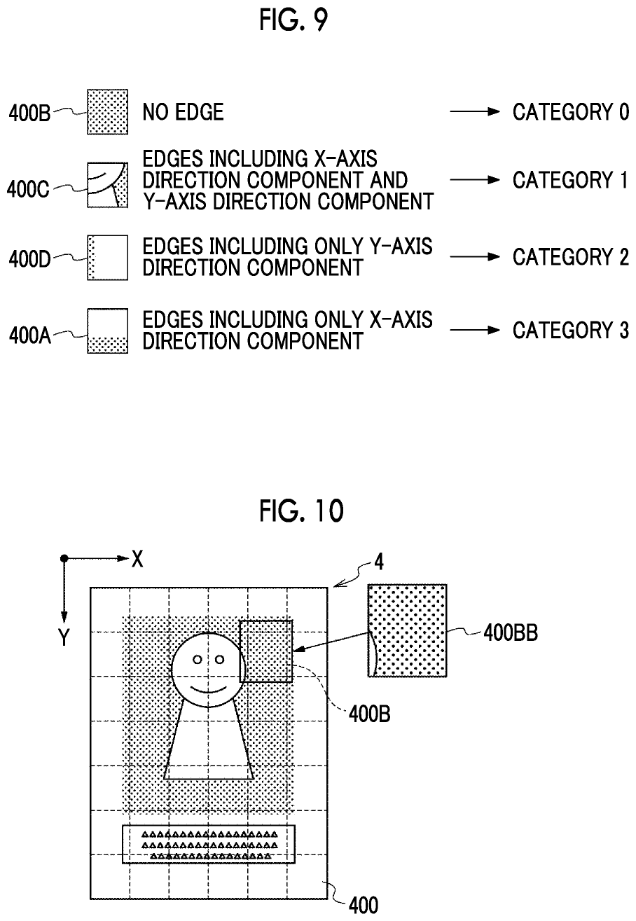

FIG. 9 is a diagram illustrating a classification example in which the reference image blocks 400 are classified into categories according to the directions of the edges. In the exemplary embodiment of the present invention, the reference image blocks 400 are classified into four categories according to the directions of the edges.

Specifically, the CPU 21 classifies the reference image blocks 400 into four categories including a category for no-edge (referred to as “category 0”), a category for which the directions of the edges include an X-axis direction component and a Y-axis direction component (referred to as “category 1”), a category for which the directions of the edges include only a Y-axis direction component (referred to as “category 2”), and a category for which the directions of the edges include only an X-axis direction component (referred to as “category 3”).

Since an edge is not extracted from the reference image block 400B, the CPU 21 classifies the reference image block 400B into the category 0.

Edges represented by a curved line and a straight line are extracted from the reference image block 400C. Since the curved line includes both of the Y-axis direction component and the X-axis direction component, the CPU 21 classifies the reference image block 400C into the category 1.

Since an edge along the Y-axis direction is extracted from the reference image block 400D, the CPU 21 classifies the reference image block 400D into the category 2.

Since an edge along the X-axis direction is extracted from the reference image block 400A, the CPU 21 classifies the reference image block 400A into the category 3.

In step S60, the CPU 21 determines whether or not there is an unselected reference image block 400 that is not yet selected in step S30 among the reference image blocks 400 divided from the reference image 4. In a case where there is an unselected reference image block 400, the process proceeds to step S30, and any one reference image block 400 is selected from the unselected reference image blocks 400. By repeatedly executing processing of each of steps S30 to S60 until it is determined that there is no unselected reference image block 400 in the determination processing of step S60, the CPU 21 classifies all the reference image blocks 400 divided from the reference image 4 into the categories.

In the determination processing of step S60, in a case where it is determined that there is no unselected reference image block 400, the process proceeds to step S70.

In step S70, the CPU 21 sets the movement direction of the reference image block 400 for each category classified according to the directions of the edges.

For example, since the reference image block 400 included in the category 3 includes only edges along the X-axis direction, even in a case where the reference image block 400 is moved in the X-axis direction, it is difficult to detect a collation position between the reference image block 400 and the read image block 200 corresponding to the reference image block 400.

Therefore, a direction intersecting with the direction of the edge, specifically, a direction orthogonal to the direction of the edge may be set as the movement direction of the reference image block 400. That is, the CPU 21 sets the movement direction of each reference image block 400 included in the category 3 to the Y-axis direction.

For the same reason, since the reference image block 400 included in the category 2 includes only edges along the Y-axis direction, the CPU 21 sets the movement direction of each reference image block 400 included in the category 2 to the X-axis direction orthogonal to the Y-axis direction.

Since the reference image block 400 included in the category 1 includes edges along the X-axis direction and the Y-axis direction, the CPU 21 sets the movement direction of each reference image block 400 included in the category 1 to the X-axis direction and the Y-axis direction.

In a case of the reference image block 400 that does not include an edge as in the reference image block 400 included in the category 0, there is no information that serves as a mark for detecting the collation position. For this reason, it is difficult to detect a collation position regardless of the movement direction of the reference image block 400. Therefore, the CPU 21 does not set the movement direction for each reference image block 400 included in the category 0 to any direction.

That is, the movement direction which is set for the reference image block 400 is restricted to a movement direction in which a collation position is most easily detected among all the movement directions.

In step S80, the CPU 21 selects any one reference image block 400 from the reference image blocks 400 classified into categories.

In step S90, the CPU 21 determines whether or not the selected reference image block 400 includes an edge, that is, whether or not the selected reference image block 400 is a reference image block 400 classified into the category 0. In a case where the selected reference image block 400 includes an edge, the process proceeds to step S100.

In step S100, the CPU 21 moves the selected reference image block 400 in the movement direction which is set for the selected reference image block 400, detects a collation position between the selected reference image block 400 and the read image block 200 corresponding to the selected reference image block 400, and calculates a deviation between the selected reference image block 400 and the read image block 200 from a movement amount of the selected reference image block 400. A known method such as pattern recognition may be used to detect the collation position.

For example, in a case where the selected reference image block 400 is classified into the category 1, the CPU 21 moves the selected reference image block 400 in the X-axis direction and the Y-axis direction, and calculates the deviation from the corresponding read image block 200.

In a case where the selected reference image block 400 is classified into the category 2, the CPU 21 moves the selected reference image block 400 in the X-axis direction, and calculates the deviation from the corresponding read image block 200.

In a case where the selected reference image block 400 is classified into the category 3, the CPU 21 moves the selected reference image block 400 in the Y-axis direction, and calculates the deviation from the corresponding read image block 200.

Specifically, in a case where the selected reference image block 400 is the reference image block 400A of FIG. 8A, the CPU 21 moves the reference image block 400A from the reference position in the Y-axis direction, and calculates the deviation from the read image block 200A illustrated in FIG. 8B, the read image block 200A being the read image block 200 corresponding to the reference image block 400A.

In a case where the selected reference image block 400 is the reference image block 400C of FIG. 8A, the CPU 21 moves the reference image block 400C from the reference position in the X-axis direction and the Y-axis direction, and calculates the deviation from the read image block 200C illustrated in FIG. 8B, the read image block 200C being the read image block 200 corresponding to the reference image block 400C.

In a case where the selected reference image block 400 is the reference image block 400D of FIG. 8A, the CPU 21 moves the reference image block 400D from the reference position in the X-axis direction, and calculates the deviation from the read image block 200D illustrated in FIG. 8B, the read image block 200D being the read image block 200 corresponding to the reference image block 400D.

In step S110, the CPU 21 stores, in the RAM 23, the deviation between the selected reference image block 400 and the read image block 200 corresponding to the selected reference image block 400, the deviation being calculated in step S100.

On the other hand, in the determination processing of step S90, in a case where it is determined that the selected reference image block 400 does not include an edge, it is more difficult to calculate the deviation from the corresponding read image block 200 using the selected reference image block 400 as compared with a case where the deviation from the corresponding read image block 200 is calculated using the reference image block 400 including an edge.

Therefore, the CPU 21 proceeds to step S120 without executing processing of step S100 and processing of step S110.

In a case where the reference image block 400 that does not include an edge is used to calculate the deviation from the read image block 200 corresponding to the reference image block 400, since there is no information that serves as a mark for detecting the collation position in the reference image block 400, it is more difficult to detect the collation position as compared with a case where the collation position is detected using the reference image block 400 including an edge. Further, in this case, even in a case where the collation position can be detected using a certain known method, an accuracy in detection of the obtained collation position is low.

Therefore, by not using the reference image block 400 that does not include an edge in the inspection of the deviation between the reference image block 400 and the read image block 200, an inspection time may be shortened and an inspection accuracy may be improved.

In step S120, the CPU 21 determines whether or not there is an unselected reference image block 400 that is not yet selected in step S80 among the reference image blocks 400 classified into the categories. In a case where there is an unselected reference image block 400, the process proceeds to step S80, and any one reference image block 400 is selected from the unselected reference image blocks 400 classified into the categories. By repeatedly executing processing of each of steps S80 to S120 until it is determined that there is no unselected reference image block 400 in the determination processing of step S120, for each reference image block 400, the deviation from the read image block 200 corresponding to the reference image block 400 is calculated.

On the other hand, in the determination processing of step S120, in a case where it is determined that there is no unselected reference image block 400, the process proceeds to step S130.

In step S130, in a case where an average value of the deviations between the reference image blocks 400 and the read image blocks 200 corresponding to the reference image blocks 400 is smaller than the reference threshold value, the deviation being stored, for example, in the RAM 23 for each reference image block 400 in step S110, the CPU 21 sets an inspection result to “pass”. On the other hand, in a case where the average value of the deviations is equal to or larger than the reference threshold value, the CPU 21 sets an inspection result to “fail”. The CPU 21 outputs the inspection result of the printed matter corresponding to the read image 2, and ends the inspection processing illustrated in FIG. 7.

As described above, the image inspection apparatus 10 according to the exemplary embodiment of the present invention calculates the deviation from the read image block 200 corresponding to the reference image block 400 by setting the movement direction of the reference image block 400 from the directions of the edges included in the reference image block 400 and detecting the collation position while moving the reference image block 400 only in the movement direction which is set. Therefore, a time required for the inspection can be shortened as compared with a case of detecting the collation position while moving the reference image block 400 in all directions without setting the movement direction of the reference image block 400.

In the inspection processing described above, the reference image blocks 400 are classified into four categories according to the directions of the edges. On the other hand, there is no restriction on the number of categories for classification. For example, the category may be subdivided as in a case where an edge including only components in a direction at an angle of 45 degrees with respect to the X-axis direction is classified into a category 4. The movement direction of the reference image block 400 classified into the category 4 may be set to a direction orthogonal to the direction of the edge, similarly to the reference image block 400 classified into other categories. Therefore, in this case, the CPU 21 moves the reference image block 400 in a direction at an angle of 45 degrees with respect to the X-axis direction, and detects the collation position between the reference image block 400 and the read image block 200 corresponding to the reference image block 400.

Further, the CPU 21 may set a direction orthogonal to the direction of the edge included in the reference image block 400 to the movement direction of the reference image block 400 without classifying the reference image block 400 into a category, and associate the reference image block 400 with the movement direction which is set.

Further, in the inspection processing described above, since the reference image block 400B of FIG. 8A does not include an edge, the deviation between the reference image block 400B and the read image block 200B is not calculated. On the other hand, in a case where there is a deviation in the read image 2, the read image block 200B may include an edge as illustrated in FIG. 8B.

In step S20 of FIG. 7, the CPU 21 divides the reference image 4 such that the adjacent reference image blocks 400 do not overlap with each other. On the other hand, as illustrated in FIG. 10, in a case where the reference image block 400B is expanded to a size larger than a predetermined size, the extended reference image block 400B (referred to as a “reference image block 400BB”) may include an edge of the block image, and the deviation from the read image block 200B may be calculated.

Therefore, in step S20 of FIG. 7, the CPU 21 may divide the reference image 4 into the reference image blocks 400, which are expanded to a size larger than a predetermined size according to a degree of the deviation of the read image 2.

The CPU 21 determines whether or not to expand the size of the reference image block 400, and determines an amount of expansion of the reference image block 400 in a case where it is determined to expand the size of the reference image block 400, based on history information in which a tendency of the deviation between the read image 2 and the reference image 4 is recorded so far. For example, in a case where, in each of a plurality of printed matters having the identical type, an average value of deviations between the read image 2 and the reference image 4 is 3 pixels, the CPU 21 divides the reference image 4 into the reference image blocks 400 which are respectively enlarged by 3 pixels in the X-axis direction and the Y-axis direction from a predetermined size. Each of the expanded reference image blocks 400 overlaps with the expanded range, that is, the adjacent reference image block 400 by 3 pixels.

Further, the CPU 21 may divide only a specific reference image block 400 into an expanded size larger than a predetermined size. For example, the reference image block 400 that does not include an edge in a case of being divided into a predetermined size may be expanded to a size such that the reference image block 400 includes any edge.

Further, the CPU 21 may divide the reference image 4 into the reference image blocks 400 which are reduced to a size smaller than the predetermined size. By reducing the reference image blocks 400 to a size smaller than the predetermined size, an amount of information included in each reference image block 400 becomes smaller than an amount of information included in each reference image block 400 in a case where the reference image block 400 is divided into the predetermined size. Therefore, it becomes easier to detect the collation position than in a case where the collation position is detected using the reference image block 400 having a predetermined size as it is.

Further, in step S20 of FIG. 7, the CPU 21 may change the size of each reference image block 400 according to complexity of the reference image 4 at a position of the reference image block 400, instead of dividing the reference image 4 into the reference image blocks 400 having the predetermined identical size.

For example, as the reference image 4 includes a more complicated portion, edges are entangled with each other, and as a result, it becomes difficult to detect the collation position between the read image block 200 and the reference image block 400. Thus, in step S20 of FIG. 7, as the reference image 4 includes a more complicated portion, the CPU 21 further reduces the size of the reference image block 400 including the portion. Therefore, it becomes easier to detect the collation position between the read image block 200 and the reference image block 400. A fact that the collation position between the read image block 200 and the reference image block 400 can be easily detected leads to an improvement in the inspection accuracy of the deviation between the read image 2 and the reference image 4.

The CPU 21 sets the complexity at each position of the reference image 4 according to, for example, the number of edges at each position of the reference image 4. On the other hand, the CPU 21 may set the complexity at each position of the reference image 4 according to, for example, a variation in the directions of the edges, that is, a variance value in the directions of the edges, instead of the number of edges at each position of the reference image 4. As the reference image 4 includes a portion having a larger variation in the directions of the edges, it is considered that the reference image 4 includes a more complicated portion. Thus, the CPU 21 divides the reference image 4 such that a size of the reference image block 400 including the portion is smaller than a predetermined size.

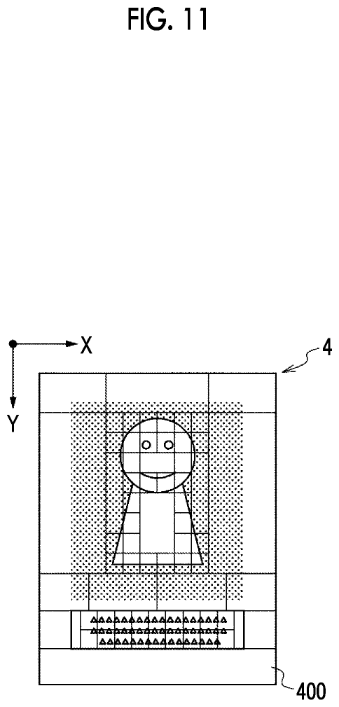

FIG. 11 is a diagram illustrating an example in which the reference image 4 illustrated in FIG. 3 is divided into the reference image blocks 400 having different sizes according to the complexity of the reference image 4. As illustrated in FIG. 11, as the reference image block 400 is located at a position at which the number of the included edges is larger, the reference image block 400 is divided into a smaller size.

Further, in step S20 of FIG. 7, the CPU 21 divides the received read image 2 into the read image blocks 200. On the other hand, in a case where the read image 2 and the reference image 4 are divided after rough alignment such that the read image 2 and the reference image 4 overlap with each other as much as possible, a matching degree between the read image 2 and the reference image 4 is higher than a matching degree between the read image 2 and the reference image 4 before alignment. Thereby, in step S100, it becomes easier to calculate the deviation between the reference image block 400 and the read image block 200 corresponding to the reference image block 400.

Therefore, preferably, for example, the CPU 21 performs affine transformation on the read image 2 such that the read image 2 and the reference image 4 match with each other as much as possible, and then respectively divides the read image 2 and the reference image 4 into the read image blocks 200 and the reference image blocks 400. The affine transformation is processing such as enlargement, reduction, or rotation on the read image 2, and a linear deviation between the read image and the reference image 4 is corrected by the affine transformation.

Since the linear deviation between the read image 2 and the reference image 4 is corrected by the affine transformation, a deviation obtained by detecting the collation position by moving the reference image block 400 with respect to the read image block 200 corresponding to each reference image block 400 is a non-linear deviation between the read image 2 and the reference image 4.

One aspect of the image inspection apparatus 10 has been described based on the exemplary embodiment of the present invention. On the other hand, the disclosed form of the image inspection apparatus 10 is an example, and the form of the image inspection apparatus 10 is not limited to the scope described in the exemplary embodiment. Various modifications and improvements may be added to the exemplary embodiment without departing from the spirit of the present disclosure, and an exemplary embodiment obtained by adding the modifications and improvements falls within a technical scope of the present disclosure. For example, the order of the inspection processing illustrated in FIG. 7 may be changed without departing from the spirit of the present disclosure.

Further, in the exemplary embodiment, a form in which the inspection processing is realized by software has been described as an example. On the other hand, the same processing as the flowchart illustrated in FIG. 7 may be performed by hardware. In this case, the processing speed may be increased as compared with a case where the inspection processing is realized by software.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

In the above exemplary embodiment, an example in which the image inspection program is stored in the ROM 22 of the image inspection apparatus 10 has been described. On the other hand, a storage destination of the image inspection program is not limited to the ROM 22. The image inspection program according to the present disclosure may also be provided by being recorded on a storage medium which can be read by the computer 20. For example, the image inspection program may be provided by being recorded on an optical disk such as a compact disk read only memory (CD-ROM) and a digital versatile disk read only memory (DVD-ROM). Further, the image inspection program may be provided by being recorded in a portable semiconductor memory such as a USB (Universal Serial Bus) memory and a memory card. The ROM 22, the non-volatile memory 24, the CD-ROM, the DVD-ROM, the USB, and the memory card are examples of a non-transitory storage medium.

Further, the image inspection apparatus 10 may download the image inspection program from an external apparatus via the communication unit 27, and store the downloaded image inspection program in, for example, the non-volatile memory 24. In this case, the CPU 21 of the image inspection apparatus 10 reads the image inspection program downloaded from the external apparatus, and executes the inspection processing.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image inspection apparatus comprising a processor configured to:
divide a read image obtained by reading a printed image and a reference image representing an original shape of the printed image into a plurality of regions having the identical shape, respectively;
set a movement direction of the region for each of the divided regions of the reference image according to a feature of the reference image in the region; and
inspect a deviation between the read image and the reference image for each of corresponding regions of the read image and the reference image by moving the region of the reference image in the movement direction which is set for the region.

2. The image inspection apparatus according to claim 1,
wherein the processor is configured to set the movement direction of each region of the divided regions of the reference image according to a direction of a contour line of the reference image in the region.

3. The image inspection apparatus according to claim 2,
wherein, in a case where directions of all contour lines of the reference image in the region face one direction, the processor is configured to set the movement direction of the region to a direction intersecting with the one direction.

4. The image inspection apparatus according to claim 2, wherein,
in a case where the reference image in the region does not include a contour line, the processor is configured to set the movement direction of the region so as not to be associated with any direction, and
in the inspection of the deviation between the read image and the reference image, the processor is configured to do not use the region of the reference image that does not include a contour line.

5. The image inspection apparatus according to claim 3, wherein,
in a case where the reference image in the region does not include a contour line, the processor is configured to set the movement direction of the region so as not to be associated with any direction, and
in the inspection of the deviation between the read image and the reference image, the processor is configured to do not use the region of the reference image that does not include a contour line.

6. The image inspection apparatus according to claim 1,
wherein the processor is configured to expand the region of the reference image to a size larger than a predetermined size, and divide the reference image into the plurality of regions such that a range of the expanded region overlaps with another region of the reference image.

7. The image inspection apparatus according to claim 2,
wherein the processor is configured to expand the region of the reference image to a size larger than a predetermined size, and divide the reference image into the plurality of regions such that a range of the expanded region overlaps with another region of the reference image.

8. The image inspection apparatus according to claim 3,
wherein the processor is configured to expand the region of the reference image to a size larger than a predetermined size, and divide the reference image into the plurality of regions such that a range of the expanded region overlaps with another region of the reference image.

9. The image inspection apparatus according to claim 4,
wherein the processor is configured to expand the region of the reference image to a size larger than a predetermined size, and divide the reference image into the plurality of regions such that a range of the expanded region overlaps with another region of the reference image.

10. The image inspection apparatus according to claim 5,
wherein the processor is configured to expand the region of the reference image to a size larger than a predetermined size, and divide the reference image into the plurality of regions such that a range of the expanded region overlaps with another region of the reference image.

11. The image inspection apparatus according to claim 6,
wherein the processor is configured to set an expansion amount of the divided region of the reference image by using history information in which a tendency of the deviation between the read image and the reference image is recorded.

12. The image inspection apparatus according to claim 7,
wherein the processor is configured to set an expansion amount of the divided region of the reference image by using history information in which a tendency of the deviation between the read image and the reference image is recorded.

13. The image inspection apparatus according to claim 8,
wherein the processor is configured to set an expansion amount of the divided region of the reference image by using history information in which a tendency of the deviation between the read image and the reference image is recorded.

14. The image inspection apparatus according to claim 9,
wherein the processor is configured to set an expansion amount of the divided region of the reference image by using history information in which a tendency of the deviation between the read image and the reference image is recorded.

15. The image inspection apparatus according to claim 10,
wherein the processor is configured to set an expansion amount of the divided region of the reference image by using history information in which a tendency of the deviation between the read image and the reference image is recorded.

16. The image inspection apparatus according to claim 1,
wherein the processor is configured to change a size of each region of the reference image according to complexity of the reference image corresponding to a position of the region.

17. The image inspection apparatus according to claim 2,
wherein the processor is configured to change a size of each region of the reference image according to complexity of the reference image corresponding to a position of the region.

18. The image inspection apparatus according to claim 16,
wherein the processor is configured to set the complexity of the reference image corresponding to the position of the region according to the number of contour lines of the reference image corresponding to the position of the region.

19. The image inspection apparatus according to claim 1,
wherein the processor is configured to perform processing of at least one of enlargement, reduction, or rotation on the read image before dividing the read image and the reference image into the plurality of regions such that a matching degree between the reference image and the processed read image is higher than a matching degree between the reference image and the unprocessed read image.

20. A non-transitory computer readable medium storing an image inspection program causing a computer to execute a process comprising:
dividing a read image obtained by reading a printed image and a reference image representing an original shape of the printed image into a plurality of regions having the identical shape, respectively;
setting a movement direction of the region for each of the divided regions of the reference image according to a feature of the reference image in the region; and
inspecting a deviation between the read image and the reference image for each of corresponding regions of the read image and the reference image by moving the region of the reference image in the movement direction which is set for the region.
